(19) United States
(12) Patent Application Publication
(10) Pub. No.: US 2018/0008869 A1
(43) Pub. Date: Jan. 11, 2018

(54) INFLATION NEEDLE, ITS MOLD AND METHOD OF MANUFACTURING SAME

(71) Applicant: Wan-Sheng YU, Taipei (TW)

(72) Inventor: Wan-Sheng YU, Taipei (TW)

(21) Appl. No.: 15/592,340

(22) Filed: May 11, 2017

Related U.S. Application Data
(63) Continuation-in-part of application No. 15/202,617, filed on Jul. 6, 2016, now abandoned.

(51) Int. Cl. A63B 41/12; B29C 35/16; B29B 13/02; B29C 45/40; B29C 45/73; B29C 45/26; B29L 31/00; B29K 105/00

(52) U.S. Cl. CPC A63B 41/12; B29C 45/73; B29C 35/16; B29C 45/26; B29B 13/022; B29C 45/40; B29C 2035/1616; B29K 2105/251; B29L 2031/759

(57) ABSTRACT

An inflation needle, its mold and method of manufacturing same are provided. The inflation needle (10) includes a hollow cylindrical probe (12); a hollow conic base (14) disposed at one end of the hollow cylindrical probe (12); a hollow externally threaded member (16) projected out of the hollow conic base (14), the hollow externally threaded member (16) being distal the hollow cylindrical probe (12) and communicating therewith; and a plurality of handles (18) disposed on an outer surface of the hollow conic base (14).

### CROSS-REFERENCE TO RELATED APPLICATIONS

This application is a continuation-in-part of U.S. patent application Ser. No. 15/202,617 entitled “INFLATION NEEDLE DEVICE FOR HOLLOW OBJECT” filed Jul. 6, 2016 which is incorporated by reference for all purposes, and is now pending.

### BACKGROUND OF THE INVENTION

### 1. Field of the Invention

The invention relates to inflation needles same and more particularly to an inflation needle having handles for ease inserting the inflation needle into a ball, its mold and method of manufacturing same, the produced inflation needle having a smooth outer surface and uniform thickness.

### 2. Description of Related Art

A conventional inflation needle is made of metallic material or plastic. For a metal inflation needle, its manufacturing process is very complicated. In short, an upper part of the inflation needle and a lower part thereof are manufactured separated prior to fastening together by riveting. Thus, its manufacturing cost is very high. Further, the inflation needle is subject to breakage at the riveted portion after a period of time of use. This problem may occur in the inflation needle disclosed by U.S. Pat. Nos. 4,049,160, 5,915,407 and 6,923,222. For an inflation needle made by injection molding, a final step of polishing step is required because its surface is rough due to contraction during injection. This inevitably increases the manufacturing cost. This problem may occur in the inflation needle disclosed by U.S. Pat. Nos. 4,043,356 and 7,730,913. For U.S. Pat. No. 7,730,913, the inflation needle is subject to breakage at the portion of the base joined the probe during use. Further, the inflation needle, whether made of metallic material or plastic, does not provide hand gripping means for user easily holding the stem thereof when inflating a ball. Thus, the need for improvement still exists.

### SUMMARY OF THE INVENTION

It is therefore one object of the invention to provide an inflation needle, its mold and method of manufacturing same by injection molding. The finished inflation needle has a smooth outer surface and uniform thickness. Further, the finished inflation needle has an improved quality and is flexible. The invention is without problems including the final step of polishing a half-finished inflation needle of the conventional art.

In a first aspect of the invention there is provided an inflation needle comprising a hollow cylindrical probe; a hollow conic base disposed at one end of the hollow cylindrical probe; a hollow internally threaded member projected out of the hollow conic base, the hollow internally threaded member being distal the hollow cylindrical probe and communicating therewith; and at least of handles disposed on an outer surface of the hollow conic base.

In a second aspect of the invention there is provided an inflation needle mold comprising a male half; a female half; at least one cores; at least one draw plates; at least one seats; and at least one internally threaded members; characterized in that the cores, the draw plates, the seats, and the internally threaded members are sandwiched by the male half and the female half; at least one exhaust gaps each is provided between the internally threaded member and the core; and at least one sprue is provided in front of a smaller diameter of the cores mold for introducing molten plastic material into the mold.

In a third aspect of the invention there is provided a method of manufacturing an inflation needle comprising the steps of joining a male half and a female half together to form a mold; initially heating the mold to a temperature between 50 and 80 degrees Celsius; heating plastic granules to a temperature between 150 and 200 degrees Celsius until the plastic granules are molten; introducing the molten material into the mold through a sprue; expelling hot air from the mold through at least one exhaust gaps each between an internally threaded member and a core until the mold is about half vacuum, thereby facilitating flow of the molten material to completely fill the molten material in the mold, resulting in a half-finished inflation needle having uniform thickness; cooling the mold to shape the half-finished inflation needle; removing the half-finished inflation needle from of the mold; and cooling the half-finished inflation needle at a temperature between 5 and 15 degrees Celsius for 5 to 15 minutes into the water to produce a finished inflation needle having a smooth outer surface and uniform thickness.

The invention has the following advantages and benefits in comparison with the conventional art: The produced inflation needle has a smooth outer surface and uniform thickness.

The above and other objects, features and advantages of the invention will become apparent from the following detailed description taken with the accompanying drawings.

### BRIEF DESCRIPTION OF THE DRAWINGS

FIG. 1 is a perspective view of an inflation needle according to a first preferred embodiment of the invention;

FIG. 2 is a longitudinal sectional view of the inflation needle shown in FIG. 1;

FIG. 3 is a perspective view of an inflation needle according to a second preferred embodiment of the invention;

FIG. 4 is a longitudinal sectional view of an inflation needle according to a third preferred embodiment of the invention;

FIG. 5 is a longitudinal sectional view of an inflation needle according to a fourth preferred embodiment of the invention;

FIG. 6 is an environmental view of the inflation needle shown in FIG. 1, showing the inflation needle gripped by the hand;

FIG. 7 is a longitudinal plan view of the inflation needle shown in FIG. 1 inserted into a ball;

FIG. 8 is a longitudinal sectional view of an inflation needle mold according to the invention; and

FIG. 9 is an enlarged view of the lower portion of FIG. 8.

### DETAILED DESCRIPTION OF THE INVENTION

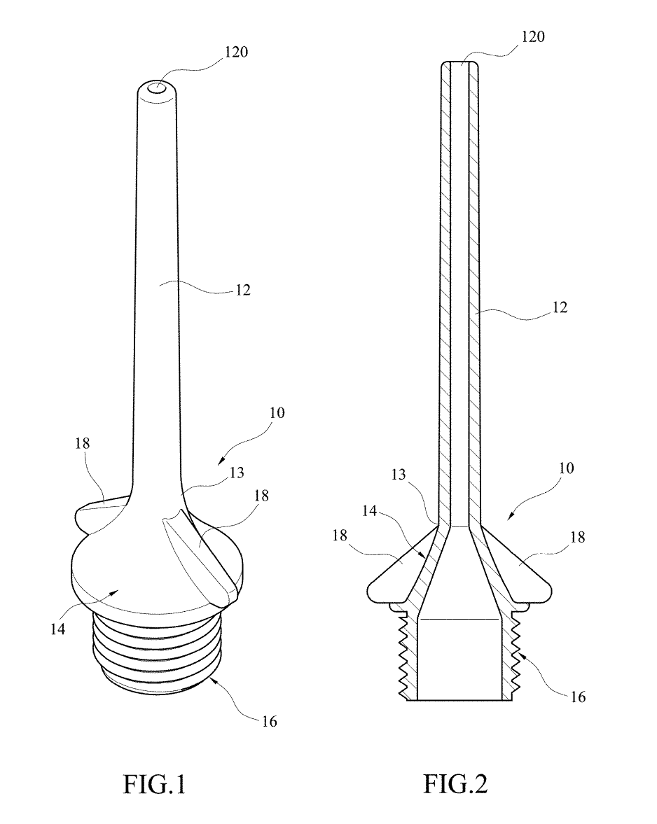

Referring to FIGS. 1, 2, 5, 6 and 7, an inflation needle 10 in accordance with a first preferred embodiment of the invention is shown and comprises the following components as discussed in detail below.

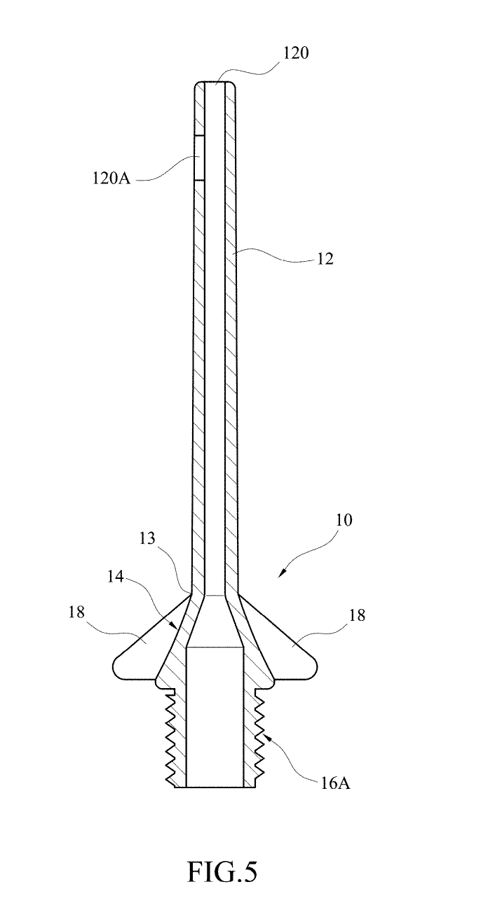

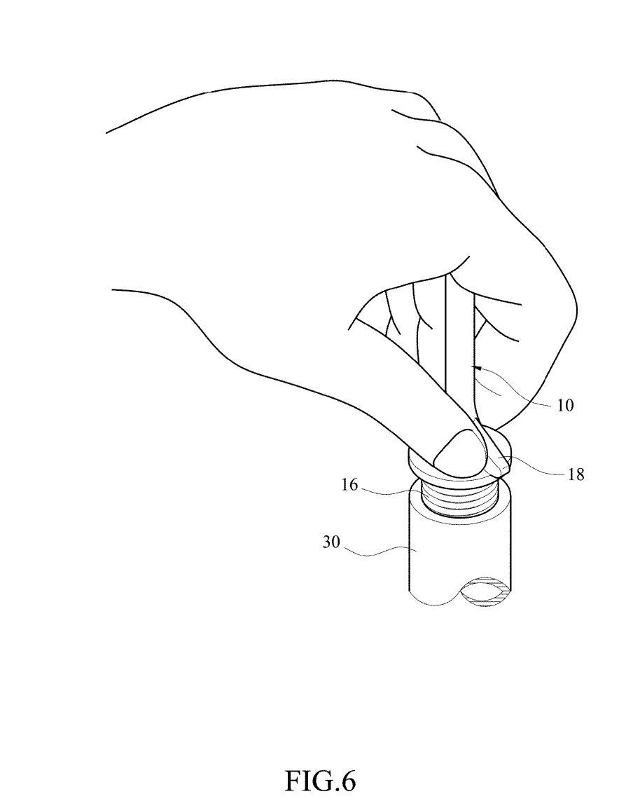

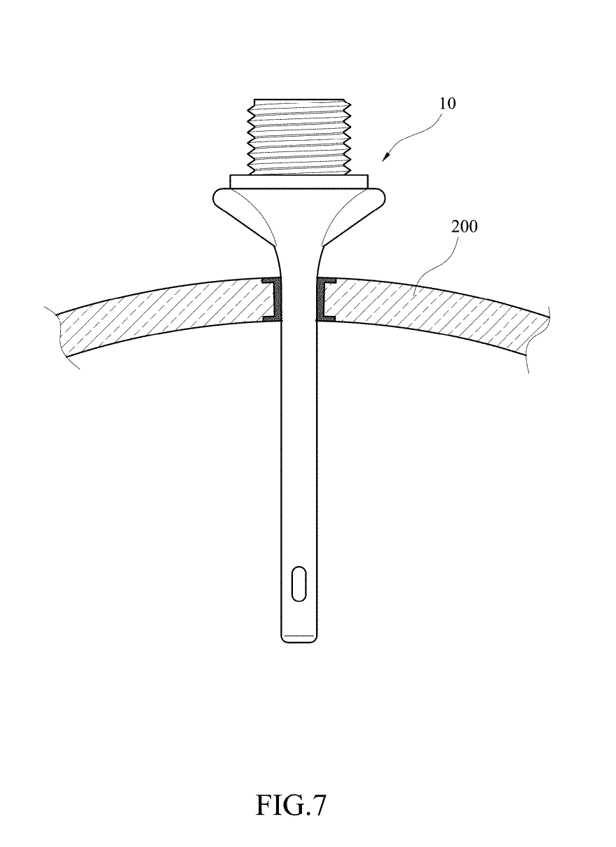

A hollow cylindrical probe 12 is formed with an enlarged, hollow conic base 14. A hollow internally threaded member 16 is projected out of the base 14. The hollow internally threaded member 16 is distal the hollow cylindrical probe 12 and communicates therewith. As shown in FIGS. 6 and 7, the probe 12 can be inserted in to a ball (e.g., basketball, soccer or the like) 200. The hollow internally threaded member 16 can be coupled to a pump 30 as shown in FIG. 6 or the like. The smaller diameter hollow internally threaded member 16A as shown in FIG. 5 can be coupled to a different pump (not shown), for example used for European specifications.

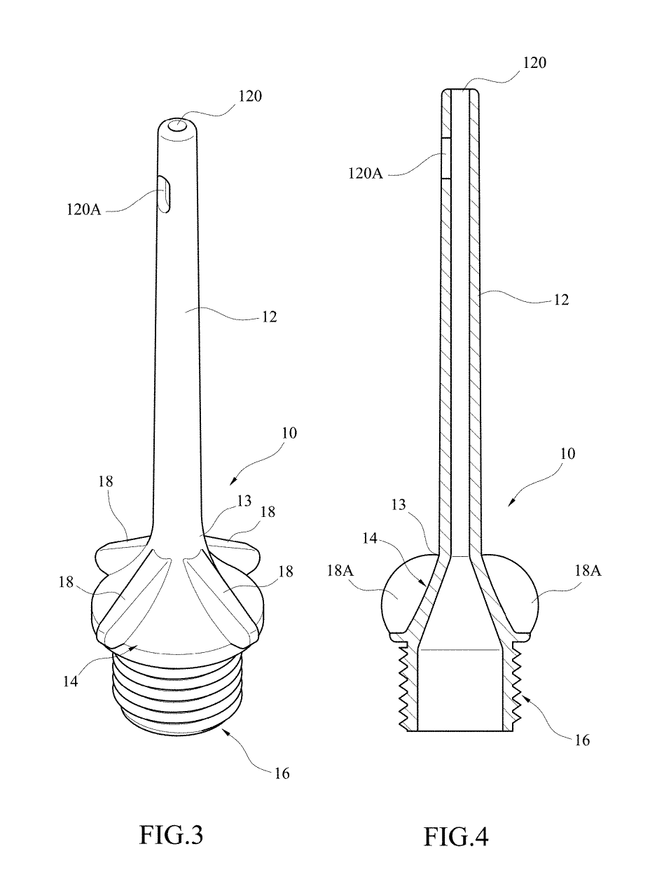

As shown in FIGS. 1 to 4, the inflation needle 10 of the invention is improved to eliminate problems associated with the conventional inflation needle. In detail, two opposite wing shaped handles 18 are provided on a conic outer surface the base 14 in the first preferred embodiment of the invention (see FIGS. 1 and 2), four equally spaced, wing shaped handles 18 are provided on the conic outer surface the base 14 in the second preferred embodiment of the invention (see FIG. 3), two opposite, half circular handles 18A are provided on the conic outer surface the base 14 in the third preferred embodiment of the invention (see FIG. 4), and two opposite, wedge shaped handles 18 (not shown) are further provided on the conic outer surface the base 14 in the fourth preferred embodiment of the invention, respectively.

A person may hold the handles 18 or 18A to attach the inflation needle 10 to the pump 30 in a facilitated manner. This characteristic is not only nonobvious but also novel. It is noted that the number of the handles 18 or 18A can be increased to a number more than two depending on applications. Further, the shape of the handle 18 or 18A can be made different from the ones shown FIGS. 1 to 5 in other embodiments.

As shown in FIGS. 2, 4 and 5, another improvement of the inflation needle 10 of the invention is that it is made by injection molding for eliminating problems associated with conventional metallic inflation needles. Therefore, the thicknesses of the probe 12, the hollow conic base 14, and the hollow externally threaded member 16 are substantially equal. This can eliminate the step of polishing the inflation needle 10 after production because the surface of the inflation needle 10 is sufficiently smooth. As a result, quality of the inflation needle 10 in increased and the manufacturing cost thereof is decreased.

As shown in FIGS. 1 to 5 again, the probe 12 includes a bore 120 extending coaxially from one end of the probe 12 to the other end thereof, and a second hole 120A proximate one end of the probe 12 and communicating with the bore 120. The hole 120A is provided as a backup for inflating air into, for example, a ball in the event of a blockage at the opening of the bore 120.

The inflation needle 10 is made of plastic such as one selected from the group consisting of heat durable plastic, nylon fiber, acrylonitrile butadiene styrene (ABS), polycarbonate (PC), fiber reinforced plastic (FRP), and polyoxymethylene (POM). The inflation needle 10 is plastic in nature irrespective of its material. Thus, in one aspect the inflation needle 10 can return to its original shape after being bent. In the other aspect the inflation needle 10 is sufficiently rigid to be capable of inserting into the bunghole of a ball (see FIGS. 6 and 7).

In other embodiments, the hollow conic base 14 includes a plurality of wing shaped handles 18 or a plurality of half circular handles 18A. The wing shaped handles 18 or the half circular handles 18A are joined the probe 12 at a neck 13. Further, the wing shaped handles 18 or the half circular handles 18A have a periphery greater than that of the neck 13 so that a person may hold and use the inflation needle 10 by user's fingers in a very facilitated way when inflating a ball. This is one of the characteristics of the invention.

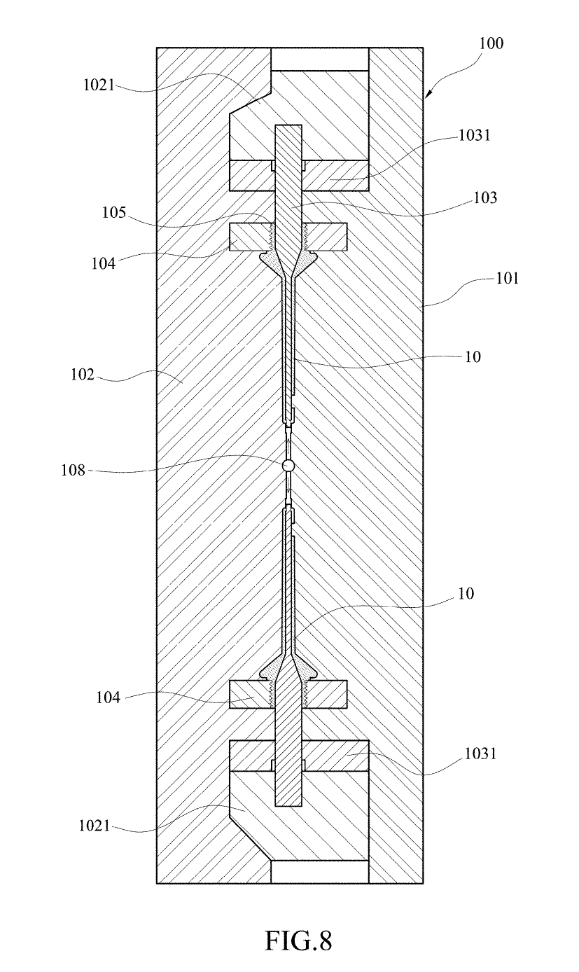

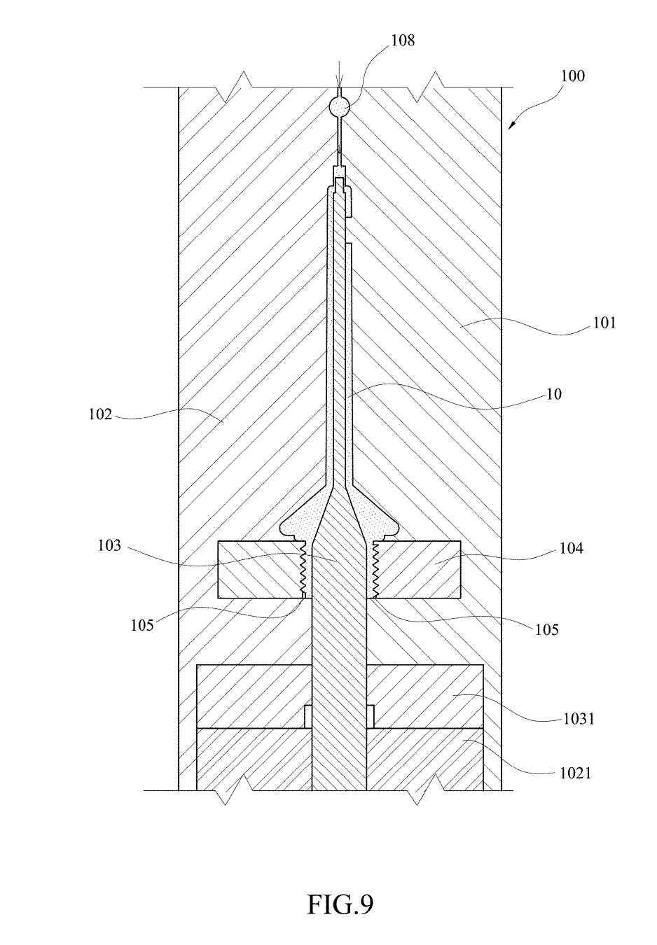

Referring to FIGS. 8 and 9, an inflation needle mold 100 of the invention is shown and includes a male half 101, a female half 102, two cores 103, two draw plates 1031, two seats 1021, and two internally threaded members 104. The cores 103, the draw plates 1031, the seats 1021, and the internally threaded members 104 are sandwiched by the male half 101 and the female half 102. Two exhaust gaps 105 each is provided between the internally threaded member 104 and the core 103. A sprue 108 is provided a smaller diameter portion of the cores 103 for introducing molten plastic material into the mold. The internally threaded members 104 are replaceable so as to comply with the specifications of an inflation needle of different countries. The hollow externally threaded member 16 can be made by means of the internally threaded member 104. It is to be appreciated that In order to simplify the drawing, the cores 103, the draw plates 1031, the seats 1021, and the internally threaded members 104 as mentioned above each only shows two of them, however, in actual application, the numbers of each are more than one.

A method of manufacturing an inflation needle in accordance with the invention comprises the following steps:
(A) joining the male half 101 and the female half 102 together to form a complete mold;
(B) initially heating the mold to a temperature between 50 and 80 degrees Celsius, or preferably a temperature between 60 and 70 degrees Celsius;
(C) heating plastic granules to a temperature between 150 and 200 degrees Celsius, or preferably a temperature between 170 and 190 degrees Celsius until the granules are molten;
(D) introducing the molten material into the mold 100 through the sprue 108;
(E) expelling hot air from the mold 100 through the exhaust gaps 105 each between the internally threaded member 104 and the core 103 until the mold is about half vacuum; this having the advantage of facilitating flow of the molten material to completely fill the molten material in the mold 100, resulting in a half-finished inflation needle having uniform thickness;
(F) cooling the mold to shape the half-finished inflation needle;
(G) removing the half-finished inflation needle from of the mold 100; and
(H) cooling in water for the half-finished inflation needle at a temperature between 5 and 15 degrees Celsius for 5 to 15 minutes to produce a finished inflation needle 100 having a smooth outer surface and uniform thickness.

While the invention has been described in terms of preferred embodiments, those skilled in the art will recognize that the invention can be practiced with modifications within the spirit and scope of the appended claims.

What is claimed is:

1. An inflation needle (10) comprising:
a hollow cylindrical probe (12);
a hollow conic base (14) disposed at one end of the hollow cylindrical probe (12);
a hollow externally threaded member (16) projected out of the hollow conic base (14), the hollow externally threaded member (16) being distal the hollow cylindrical probe (12) and communicating therewith; and
at least two of handles (18) disposed on an outer surface of the hollow conic base (14).

2. The inflation needle of claim 1, wherein the hollow cylindrical probe (12) includes a bore (120) extending coaxially from one end of the hollow cylindrical probe (12) to the other end thereof.

3. The inflation needle of claim 2, wherein the hollow cylindrical probe (12) further includes a hole (120A) proximate one end of the probe (12) and communicating with the bore (120).

4. The inflation needle of claim 1, wherein each of the handles (18) is shaped as a wing, half circle, or wedge.

5. The inflation needles of claim 1, wherein the thicknesses of the hollow cylindrical probe (12), the hollow conic base (14), and the hollow externally threaded member (16) are substantially equal; and an outer surface of the inflation needle (10) is sufficiently smooth.

6. The inflation needle of claim 1, wherein the inflation needle (10) is made of plastic selected from the group consisting of heat durable plastic, nylon fiber, acrylonitrile butadiene styrene (ABS), polycarbonate (PC), fiber reinforced plastic (FRP), and polyoxymethylene (POM).

7. An inflation needle mold (100) comprising:
a male half (101);
a female half (102);
at least one cores (103);
at least one draw plates (1031);
at least one seats (1021); and
at least one internally threaded members (104);
characterized in that
the cores (103), the draw plates (1031), the seats (1021), and the internally threaded members (104) are sandwiched by the male half (101) and the female half (102);
at least one exhaust gaps (105) each is provided between the internally threaded member (104) and the core (103); and
at least one sprue (108) is provided in front of a smaller diameter portion of the cores (103) for introducing molten plastic material into the mold (100).

8. The inflation needle mold of claim 6, wherein the internally threaded members (104) are replaceable so as to comply with different specifications of the inflation needle (10).

9. A method of manufacturing an inflation needle comprising the steps of:
(A) joining a male half (101) and a female half (102) together to form a mold (100);
(B) initially heating the mold (100) to a temperature between 50 and 80 degrees Celsius;
(C) heating plastic granules to a temperature between 150 and 200 degrees Celsius until the plastic granules are molten;
(D) introducing the molten material into the mold (100) through a sprue (108);
(E) expelling hot air from the mold (100) through two exhaust gaps (105) each between an internally threaded member (104) and a core (103) until the mold (100) is about half vacuum, thereby facilitating flow of the molten material to completely fill the molten material in the mold (100), resulting in a half-finished inflation needle having uniform thickness;
(F) cooling the mold (100) to shape the half-finished inflation needle;
(G) removing the half-finished inflation needle from of the mold (100); and
(H) cooling in water for the half-finished inflation needle at a temperature between 5 and 15 degrees Celsius for 5 to 15 minutes to produce a finished inflation needle (100) having a smooth outer surface and uniform thickness.

10. The method of claim 8, wherein the step of initially heating the mold (100) initially heats the mold (100) to a temperature between 60 and 70 degrees Celsius.

11. The method of claim 8, wherein the step of heating plastic granules heats the plastic granules to a temperature between 170 and 190 degrees Celsius.
